(19) United States
(12) Patent Application Publication
(10) Pub. No.: US 2011/0054999 A1
(43) Pub. Date: Mar. 3, 2011

(54) SYSTEM AND METHOD FOR PREDICTING USER NAVIGATION WITHIN SPONSORED SEARCH ADVERTISEMENTS

(75) Inventors: Joshua Attenberg, Roxbury, CT (US); Sandeep Pandey, Santa Clara, CA (US); Torsten Suel, New York, NY (US)

(73) Assignee: Yahoo! Inc., Sunnyvale, CA (US)

(21) Appl. No.: 12/547,473

(22) Filed: Aug. 25, 2009

(51) Int. Cl. G06Q 30/00; G06F 17/30

(52) U.S. Cl. 705/14.43; 705/14.49; 705/14.52; 707/E17.109

(57) ABSTRACT

An improved system and method for predicting user navigation within sponsored search advertisements is provided. A list of sponsored advertisements for display on a web page of search results may be received. A click prediction classifier may be applied to predict a click probability of each sponsored advertisement and a dwell time prediction classifier may be applied to predict a dwell time probability on web pages of a website of each sponsored advertisement. A probability of user navigation may be predicted for each sponsored advertisement using a probability of a click on each sponsored advertisement and a probability of a dwell time on web pages of a website of each sponsored advertisement. The list of the sponsored advertisements may be ranked in part by the probability of user navigation and served to a web browser executing on a client device for display on a web page of search results.

### FIELD OF THE INVENTION

The invention relates generally to computer systems, and more particularly to an improved system and method for predicting user navigation within sponsored search advertisements.

### BACKGROUND OF THE INVENTION

Implicit user feedback, including click-through and subsequent browsing behavior, is crucial for evaluating and improving the quality of results returned by search engines. Several studies have used post-result browsing behavior including the sites visited, the number of clicks, and the dwell time on site in order to improve the ranking of organic search results. In particular, some studies have focused on how implicit measures can be utilized to improve Web search. For instance, see E. Agichtein, E. Brill, and S. Dumais, Improving Web Search Ranking by Incorporating User Behavior Information, In Proceedings of SIGIR 2006, and T. Joachims, L. Granka, B. Pan, H. Hembrooke, F. Radlinski, and G. Gay, Evaluating the Accuracy of Implicit Feedback from Clicks and Query Reformulations in Web Search, ACM Transactions Information Systems, 25(2):7, 2007. In particular, E. Agichtein, E. Brill, and S. Dumais found that implicit feedback can improve the accuracy of an organic search ranking algorithm by almost 31%. As a result, various methods have been proposed for how to incorporate implicit measures into ranking organic search results. For instance, there is work on how to interpret click-through data accurately for organic search results (see T. Joachims, L. Granka, B. Pan, H. Hembrooke, and G. Gay, Accurately Interpreting Clickthrough Data as Implicit Feedback, In Proceedings of SIGIR 2005), identify relevant websites using past user activity for organic search results (see E. Agichtein and Z. Zheng, Identifying “Best Bet” Web Search Results by Mining Past User Behavior, In Proceedings of KDD 2006), and rank pages based on user feedback for organic search results (see F. Radlinski and T. Joachims, Query Chains: Learning to Rank from Implicit Feedback, In Proceedings of SIGKDD 2005).

However, there has failed to be similar studies of user behavior on sponsored search results (which are the advertisements displayed by search engines next to the organic search results) to exploit post-result user behavior for better ranking of sponsored advertisements. Revenue from sponsored search results provides much of the economic foundation of modern web search engines. However, sponsored search advertising differs significantly from organic search in several important ways. First, while organic search is focused on satisfying users by addressing search queries, sponsored search advertising has to optimize for advertising revenue while accounting for user satisfaction and the constraints and objectives of advertisers. Second, the ranking of advertisements in sponsored search advertising differs from that of organic search. Specifically, advertisements in sponsored search advertising are ranked in accordance with their expected revenue which is a function of advertisement bid amounts and predicted click-through rates. The latter is estimated mainly using the relevance between the short creative of the advertisement and the query terms, and broad query-wide features. More detailed features proven to be useful for ranking in organic search, for instance, hyperlink structure and anchor text information are frequently unavailable for short-lived advertisements. Third, click-through rates in sponsored search advertising tend to be lower than for organic results, suggesting users might interact differently with these results than with organic results.

What is needed is a way to improve the user experience in sponsored search advertising through the incorporation of implicit user feedback. Such a system and method should provide a prediction mechanism for forecasting user behavior in previously unseen scenarios.

### SUMMARY OF THE INVENTION

Briefly, the present invention may provide a system and method for predicting user navigation within sponsored search advertisements. In various embodiments, a web browser executing on a client device may be operably coupled to a server for receiving a list of sponsored advertisements from the server for display by the web browser on a search results page. The server may include an operably coupled prediction engine that predicts user navigation originating from a sponsored advertisement for display on a web page of search results by predicting a probability of a click on the sponsored advertisement and by predicting a probability of a dwell time on a plurality of web pages of a website of the sponsored advertisement. The prediction engine may include a click prediction classifier that predicts the probability of a click on a sponsored advertisement and may include a dwell time prediction classifier that predicts the probability of a dwell time on the web pages of a website of a sponsored advertisement. The server may also include an operably coupled navigation information ranking engine that ranks the list of sponsored advertisements by the probability of a click on each of the sponsored advertisements and by the probability of the dwell time on the web pages of each of the websites of the sponsored advertisements.

To predict user navigation within sponsored search advertisements, a click prediction classifier may be trained to predict a probability of a click on a sponsored advertisement using sets of features from sets of training data. Each set of features may include features of a user entity, features of a query, and features of a list of sponsored search results. A dwell time prediction classifier may also be trained using the sets of features from the sets of training data to predict a probability of a dwell time on web pages of a website of a sponsored advertisement. In an embodiment, a binary classifier may be trained by logistic regression using the sets of features from the sets of training data. The performance of training a binary classifier may be determined by measuring an area under a validation receiver operating characteristic curve. The classifiers may be output in an embodiment when the performance of training each binary classifier may be within a defined threshold.

A list of sponsored advertisements may be ranked at least in part by the prediction of user navigation within sponsored search advertisements and served for display on a search results page. To do so, a list of sponsored advertisements for display on a web page of a plurality of search results may be received. A probability of user navigation may be predicted for each of the sponsored advertisements using a probability of a click on each of the sponsored advertisements and a probability of a dwell time on web pages of a website of each of the sponsored advertisements. In an embodiment, features of a user entity, features of a search query and features of the list of sponsored advertisements may be input to a click prediction classifier applied to predict a probability of a click on each of the sponsored advertisements in the list and may also be input to a dwell time prediction classifier to predict a probability of a dwell time on web pages of a website of each of the sponsored advertisements in the list. The list of the sponsored advertisements may be ranked in order using, at least in part, the probability of user navigation from each of the sponsored advertisements and output, for example, by serving the list of the sponsored advertisements in rank order to a web browser executing on a client device for display on a web page of search results.

Advantageously, the present invention may accurately predict a probability of user navigation within sponsored search advertisements. Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for predicting user behavior within sponsored search advertisements, in accordance with an aspect of the present invention;

FIG. 3 is a flowchart generally representing the steps undertaken in one embodiment for predicting user navigation within sponsored search advertisements, in accordance with an aspect of the present invention;

FIG. 4 is a flowchart generally representing the steps undertaken in one embodiment for training a prediction classifier using user, query, website and web page features and training sets, in accordance with an aspect of the present invention; and

FIG. 5 is a flowchart generally representing the steps undertaken in one embodiment to rank a list of sponsored search advertisements for display on a search results page from prediction of user navigation within sponsored search advertisements, in accordance with an aspect of the present invention.

### DETAILED DESCRIPTION

### Exemplary Operating Environment

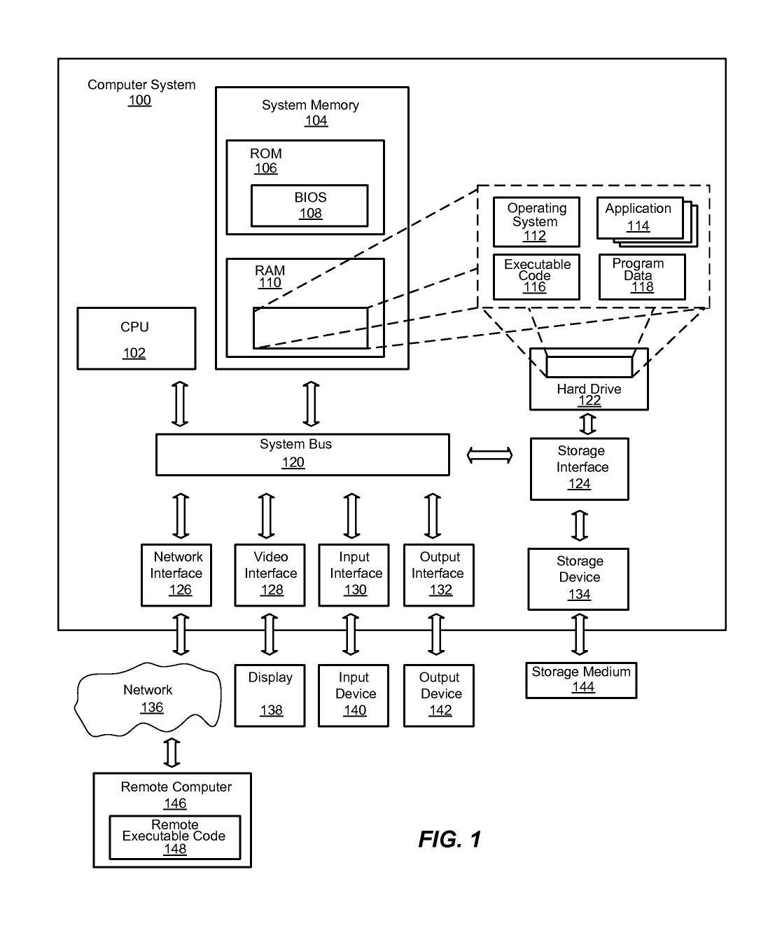

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used. Those skilled in the art will also appreciate that many of the components of the computer system 100 may be implemented within a system-on-a-chip architecture including memory, external interfaces and operating system. System-on-a-chip implementations are common for special purpose hand-held devices, such as mobile phones, digital music players, personal digital assistants and the like.

Predicting User Behavior within Sponsored Search Advertisements

The present invention is generally directed towards a system and method for predicting user behavior within sponsored search advertisements. To predict user navigation within sponsored search advertisements, a click prediction classifier may be trained to predict a probability of a click on a sponsored advertisement using sets of features from sets of training data. Each set of features may include features of a user entity, features of a query, and features of a list of sponsored search results. A dwell time prediction classifier may also be trained using the sets of features from the sets of training data to predict a probability of a dwell time on web pages of a website of a sponsored advertisement. A list of sponsored advertisements to be ranked at least in part by the prediction of user navigation within sponsored search advertisements may be received. A probability of user navigation may be predicted for each of the sponsored advertisements using a probability of a click on each of the sponsored advertisements and a probability of a dwell time on web pages of a website of each of the sponsored advertisements. The list of the sponsored advertisements may be ranked in order at least in part by the probability of user navigation from each of the sponsored advertisements and may be served in rank order to a web browser executing on a client device for display on a web page of search results.

As used herein, sponsored search advertisement means an advertisement that includes a URL of a website and that is paid for or promoted by a sponsor, such as an advertiser, for display with organic search results. As used herein, sponsored search results means a list of sponsored search advertisements that are displayed next to the organic search results on a web page. A sponsored advertisement means a sponsored search advertisement.

As will be seen, the present invention may accurately predict a probability of user navigation within sponsored search advertisements and may improve the user experience in sponsored search advertising through the incorporation of implicit user feedback. As will be understood, the various block diagrams, flow charts and scenarios described herein are only examples, and there are many other scenarios to which the present invention will apply.

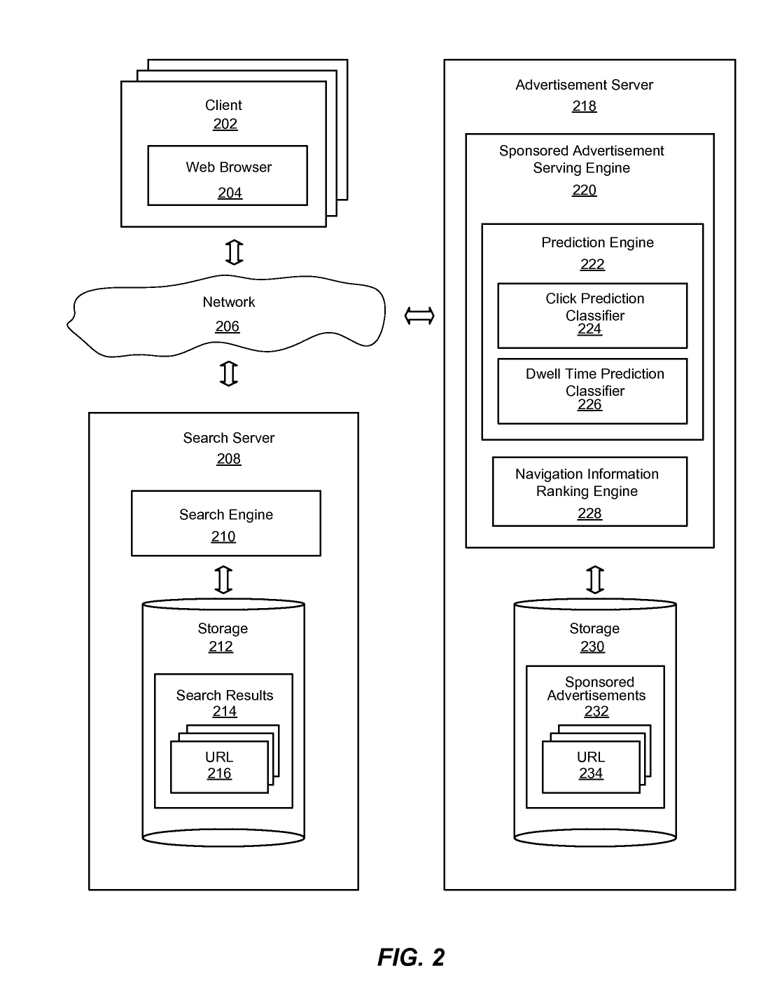

Turning to FIG. 2 of the drawings, there is shown a block diagram generally representing an exemplary architecture of system components for predicting user behavior within sponsored search advertisements. Those skilled in the art will appreciate that the functionality implemented within the blocks illustrated in the diagram may be implemented as separate components or the functionality of several or all of the blocks may be implemented within a single component. For example, the functionality for the navigation information ranking engine 228 may be included in the same component as the prediction engine 222. Or the functionality of the navigation information ranking engine 228 may be implemented as a separate component from the prediction engine 222 as shown. Moreover, those skilled in the art will appreciate that the functionality implemented within the blocks illustrated in the diagram may be executed on a single computer or distributed across a plurality of computers for execution.

In various embodiments, one or more client computers 202 may be operably coupled to a search server 208 and to an advertisement server 218 by a network 206. The client computer 202 may be a computer such as computer system 100 of FIG. 1. The network 206 may be any type of network such as a local area network (LAN), a wide area network (WAN), or other type of network. A web browser 204 may execute on the client computer 202 and may include functionality for receiving a search request which may be input by a user entering a query, functionality for sending the query request to a search engine 210 to obtain a list of search results, and functionality for receiving a list of advertisements from an advertisement server 218 for display by the web browser, for instance, in a search results page on the client computer 202. In general, the web browser 204 may be any type of interpreted or executable software code such as a kernel component, an application program, a script, a linked library, an object with methods, and so forth. The web browser 204 may alternatively be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system.

The search server 208 may be any type of computer system or computing device such as computer system 100 of FIG. 1. In general, the search server 208 may provide services for receiving a query request from a web browser 204 to obtain a list of search results 214 and for sending the list of search results 214 to the web browser 204 executing on the client computer 202. In particular, the search server 208 may include a search engine 210 that may include functionality to perform query processing to select the list of search results. The search engine 210 may be any type of executable software code such as a kernel component, an application program, a linked library, an object with methods, or other type of executable software code. The search engine may alternatively be a processing device such as an integrated circuit or logic circuitry that executes instructions represented as microcode, firmware, program code or other executable instructions that may be stored on a computer-readable storage medium. Those skilled in the art will appreciate that the search engine 210 may also be implemented within a system-on-a-chip architecture including memory, external interfaces and an operating system. The search engine 208 may be operably coupled to storage 212 which may be any computer-readable storage medium that may store search results 214 including one or more Uniform Resource Locators (URLs) 216.

The advertisement server 218 may be any type of computer system or computing device such as computer system 100 of FIG. 1. In general, the advertisement server 208 may provide services for sending a list of advertisements to the web browser 204 executing on the client computer 202 for display with the search results of query processing. In particular, the advertisement server 218 may include a sponsored advertisement serving engine 220 that may include functionality to select a list of sponsored advertisements 232 using a prediction engine 222 and a navigation information ranking engine 228, and the advertisement server 218 may serve the list of sponsored advertisements 232 to the web browser 204 executing on the client computer 202 for display with the search results 214 of query processing. The sponsored advertisement serving engine 220 may be operably coupled to storage 230 which may be any computer-readable storage medium that may store a list of sponsored advertisements 232 including one or more Uniform Resource Locators (URLs) 234 of a website of a sponsored advertisement. The sponsored advertisement serving engine 220 may include a prediction engine 222 that predicts user navigation originating from a sponsored advertisement and a navigation information ranking engine 228 that ranks sponsored advertisements at least in part by the prediction of user navigation originating from a sponsored advertisement. The prediction engine 222 may also include a click prediction classifier 224 that predicts the probability of a click on a sponsored advertisement and a dwell time prediction classifier 226 that predicts the probability of a dwell time on web pages of a website of a sponsored advertisement. Each of these components of the advertiser server 218 may also be any type of executable software code such as a kernel component, an application program, a linked library, an object with methods, or other type of executable software code. These components may alternatively be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system.

Sponsored advertisement applications may use the present invention to provide a list of sponsored search advertisements for display on the search results page of a client browser in online advertising. When a user may submit a search query request, the present invention may be used to predict user navigation within sponsored search advertisements and to rank a list of sponsored search advertisements for display on a search results page. In various embodiments, the list of sponsored search advertisements may appear in the sponsored search results area of the search results page. To predict user navigation from sponsored search advertisements, the user navigation trail of the sequence of web pages viewed on a website of a sponsored search advertisement may be analyzed to determine (a) the number of clicks the user makes on the trail which represents the trail length, and (b) the total time spent in the trail which represents the trail duration. In an embodiment, these two numbers may provide a useful synopsis of user navigation behavior originating from sponsored search advertisements and may be used to predict user navigation originating from sponsored search advertisements.

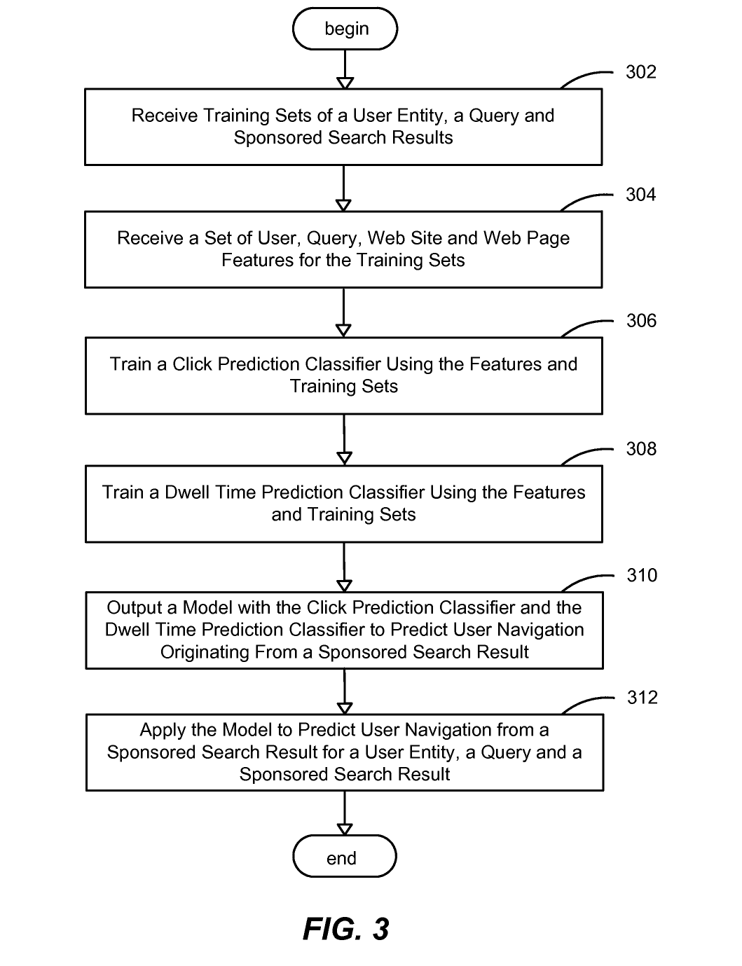

FIG. 3 presents a flowchart generally representing the steps undertaken in one embodiment for predicting user navigation within sponsored search advertisements. At step 302, training sets of a user entity, a query, and sponsored search results may be received. For example, features of a user entity may include an anonymous user identification, query result, navigation behavior such as number of clicks made and dwell time per website visit and so forth. Features of a query may include query terms, number of query terms, frequency of query terms and so forth. Features of sponsored search results may include a URL, anchor text, advertisement text, and so forth. At step 304, a set of user features, query features, website features and web page features may be received for the training sets.

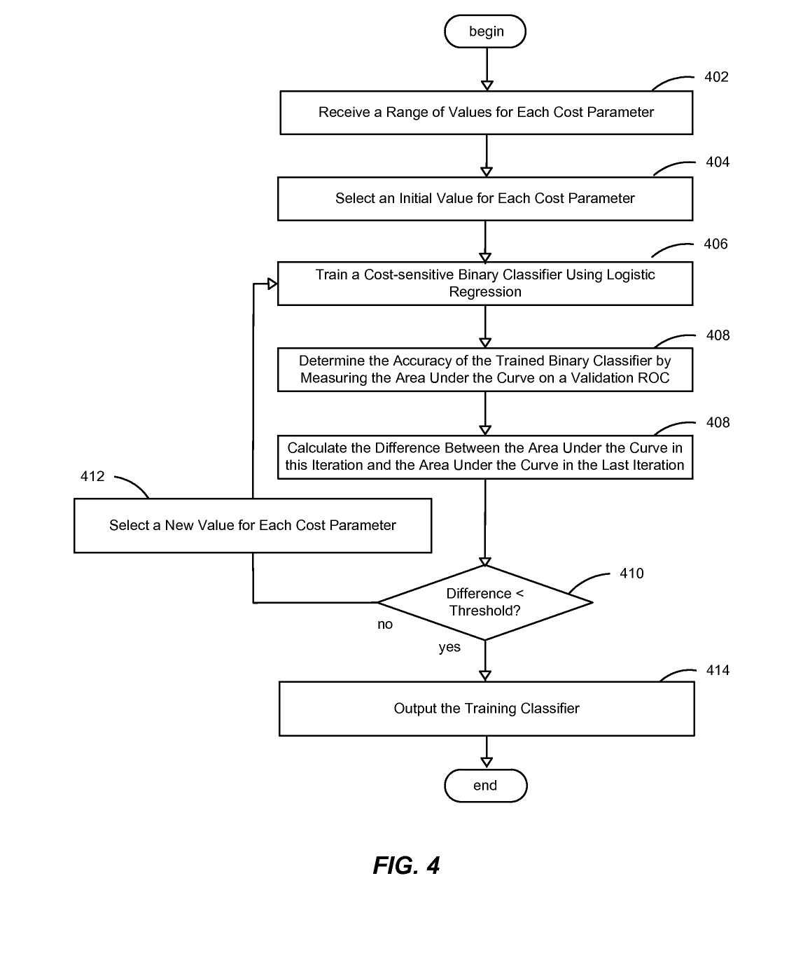

At step 306, a click prediction classifier may be trained using the training sets and the features. In an embodiment, a cost-sensitive binary classifier may be trained using the training sets and the features which may be described in more detail in conjunction with FIG. 4 below. At step 308, a dwell time prediction classifier may be trained using the training sets and the features. To train the dwell time prediction classifier, a cost-sensitive binary classifier may also be trained in an embodiment using the training sets and the features which may be described in more detail in conjunction with FIG. 4 below.

At step 310, a model with the click prediction classifier and the dwell time prediction classifier may be output to predict user navigation originating from a sponsored search result such as a sponsored search advertisement. In an embodiment, the model output may be prediction engine 220 in FIG. 2. Once the prediction engine may be constructed and output, the prediction engine may be applied at step 312 to predict user navigation from a sponsored search result, such as a sponsored search advertisement, for a user entity, a query, and a sponsored search result.

FIG. 4 presents a flowchart for generally representing the steps undertaken in one embodiment for training a prediction classifier using user, query, website and web page features and training sets. In an embodiment, the steps described in conjunction with FIG. 4 may be used to separately train a click prediction classifier and a dwell time prediction classifier. At step 402, a range of values for each cost parameter used in a cost-sensitive binary classifier may be received. In an embodiment of binary click prediction classifier for example, there may be a cost parameter for incorrectly classifying a training case for predicting an additional click, and there may be another cost parameter for incorrectly classifying a training case for predicting no additional click. In an embodiment of a binary dwell time prediction classifier as another example, there may be a cost parameter for incorrectly classifying a training case for predicting a dwell time of at least one minute, and there may be another cost parameter for incorrectly classifying a training case for predicting a dwell time of less than one minute.

At step 404, an initial value for each cost parameter may be selected. In an embodiment, an initial value may be randomly selected within the range of values received for each cost parameter. After selecting initial values for each cost parameter, a cost-sensitive binary classifier may be trained at step 406 using logistic regression with an input vector x and a weight vector w. In an embodiment a ridge estimator may be used to generalize the classifier for the training data set and to avoid overfitting the classifier for the training data set. The weight vector w may be optimized using Newton's method in an embodiment to allow convergence on a solution with fewer input training cases.

At step 408, the performance of the trained binary classifier may be determined by measuring the area under the receiver operating characteristic (ROC) curve of a validation ROC. As is well-known in the art, the ROC curve may graph the true positive rate for training data classified by a binary classifier against the false positive rate for training data classified by a binary classifier. Thus, the area under the ROC curve represents a measure of binary classifier performance. At step 408, the difference between the measure of the area under the ROC curve in the current iteration of training the binary classifier and the measure of the area under the ROC curve in the current iteration of training the binary classifier may be calculated. If the difference is less than a threshold, then the training classifier may be output at step 414. Otherwise, a new value for each cost parameter may be selected at step 412 and processing may continue at step 406 to train the binary classifier again with new values for the cost parameters.

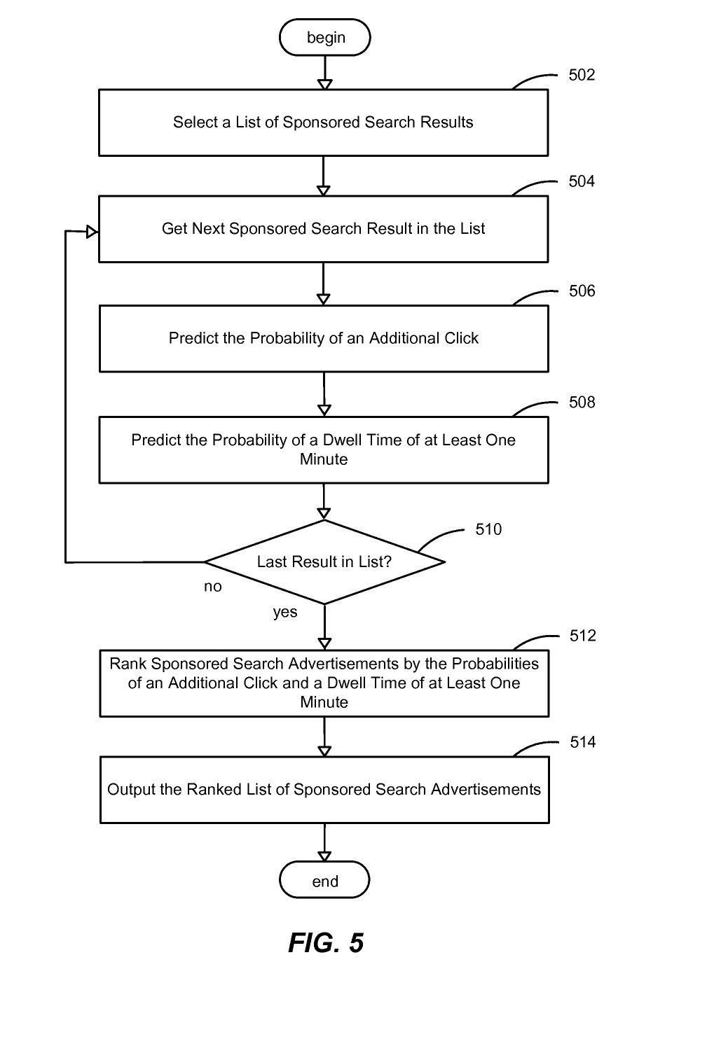

FIG. 5 presents a flowchart generally representing the steps undertaken in one embodiment to rank a list of sponsored search advertisements for display on a search results page from prediction of user navigation within sponsored search advertisements. At step 502, a list of sponsored search results may be selected. For example, a sponsored advertisement serving engine may select a list of sponsored search results. At step 504, a sponsored search result, such as a sponsored search advertisement, may be obtained from the list of sponsored search results.

At step 506, the probability of an additional click may be predicted for the sponsored search advertisement. In an embodiment, a click prediction classifier may predict the probability of an additional click by a user for the sponsored search advertisement. At step 508, a probability of a dwell time of at least one minute may be predicted for the sponsored search advertisement. In an embodiment, a dwell time prediction classifier may predict the probability of a dwell time of at least one minute by a user for the sponsored search advertisement. Those skilled in the art will appreciate that a click prediction classifier may be trained to predict various navigation trail lengths by a user, including two, three or more clicks by a user on web pages of a website of a sponsored advertisement. Similarly, those skilled in the art will appreciate that a dwell time prediction classifier may be trained to predict various navigation trail durations by a user including dwell times of tens of seconds, a half minute or two or more minutes on web pages of a website of a sponsored advertisement.

At step 510, it may be determined whether the last sponsored search result in the sponsored search results list has been processed. If not, then processing may continue at step 504 where the next sponsored search result, such as a sponsored search advertisement, may be obtained from the list of sponsored search results. Otherwise, if it may be determined that the last sponsored search result in the sponsored search results list has been processed, then the sponsored search advertisements in the search results list may be ranked at step 512 at least in part by the predicted probabilities of an additional click and a dwell time of at least one minute for each of the sponsored search advertisements. And at step 514, the ranked list of sponsored search advertisements may be output. In an embodiment, the ranked list of sponsored search advertisements may be stored in a computer-readable storage medium and sent to a client browser for display on the search results page of a client browser.

Thus the present invention may accurately forecast user behavior and improve the user experience in sponsored search advertising through the incorporation of implicit user feedback. Advantageously, the present invention may accurately predict user navigation within sponsored search results in previously unseen scenarios. Importantly, even slight increases in accuracy in predicting user navigation within sponsored search results can result in substantial increased revenue and in a better user experience, given the large scale of search engine traffic. Those skilled in the art will appreciate that there may be other implementations of incorporating implicit user feedback to predict user navigation within sponsored search advertising. In addition to a click prediction classifier and a dwell time prediction classifier, other prediction classifiers may be trained using features of a user entity, features of a query, and features of a list of sponsored search results. For example, a prediction classifier may be trained using features of web pages of a website of a sponsored search advertisement in the sponsored search results.

As can be seen from the foregoing detailed description, the present invention provides an improved system and method for predicting user navigation within sponsored search advertisements. A list of sponsored advertisements for display on a web page of search results may be received, and a click prediction classifier may be applied to predict a click probability of each sponsored advertisement and a dwell time prediction classifier may be applied to predict a dwell time probability on web pages of a website of each sponsored advertisement. A probability of user navigation may be predicted for each sponsored advertisement using a probability of a click on each sponsored advertisement and a probability of a dwell time on web pages of a website of each sponsored advertisement. The list of the sponsored advertisements may be ranked in order at least in part by the probability of user navigation and served to a web browser executing on a client device for display on a web page of search results. Advantageously, the probability of user navigation may be accurately predicted by the present invention for serving sponsored advertisements in online advertising. As a result, the system and method provide significant advantages and benefits needed in contemporary computing and in online advertising applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for sponsored search advertising, comprising:
a prediction engine that predicts user navigation originating from a sponsored advertisement for display on a web page of a plurality of search results by predicting a probability of a click on the sponsored advertisement and by predicting a probability of a dwell time on a plurality of web pages of a website of the sponsored advertisement;
a navigation information ranking engine that ranks the sponsored advertisement among a plurality of sponsored advertisements at least in part by the probability of the click on the sponsored advertisement and by the probability of the dwell time on the plurality of web pages of the website of the sponsored advertisement; and
a storage, operably coupled to the navigation information ranking engine, that stores the sponsored advertisement including a Uniform Resource Locator.

2. The system of claim 1 further comprising a dwell time prediction classifier, operably coupled to the prediction engine, that predicts the probability of the dwell time on the plurality of web pages of the website of the sponsored advertisement.

3. The system of claim 1 further comprising a click prediction classifier, operably coupled to the prediction engine, that predicts the probability of the click on the sponsored advertisement.

4. The system of claim 1 further comprising a sponsored advertisement serving engine, operably coupled to the navigation information ranking engine, that serves the sponsored advertisement to a web browser executing on a client device for display on the web page of the plurality of search results.

5. A computer-implemented method for sponsored search advertising, comprising:
receiving a plurality of sets of features from a plurality of sets of training data, each set of the plurality of sets of features including at least one feature of at least one user entity, at least one feature of at least one query, and at least one feature of a list of sponsored search results;
training a click prediction classifier to predict a probability of a click on a plurality of sponsored advertisements using the plurality of sets of features from the plurality of sets of training data, each set of the plurality of sets of features including at least one feature of the at least one user entity, at least one feature of the at least one query, and at least one feature of the list of sponsored search results;
training a dwell time prediction classifier to predict a probability of a dwell time on a plurality of web pages of a website of each of the plurality of sponsored advertisements using the plurality of sets of features from the plurality of sets of training data, each set of the plurality of sets of features including at least one feature of the at least one user entity, at least one feature of the at least one query, and at least one feature of the list of sponsored search results; and
outputting a model including the click prediction classifier and the dwell time prediction classifier that predicts a probability of user navigation originating from a sponsored search result.

6. The method of claim 5 further comprising receiving a plurality of sets of training data, each set of the plurality of sets of training data including the at least one user entity, the at least one query, and the at least one list of sponsored search results.

7. The method of claim 5 further comprising receiving a range of values for at least one cost parameter used to train a binary classifier.

8. The method of claim 7 further comprising selecting an initial value from the range of values for the at least one cost parameter used to train the binary classifier.

9. The method of claim 8 further comprising training the binary classifier using logistic regression to predict the probability of the click on the plurality of sponsored advertisements using the plurality of sets of features from the plurality of sets of training data.

10. The method of claim 9 further comprising:
determining a performance of training the binary classifier by measuring an area under a validation receiver operating characteristic curve;
calculating a difference between a measurement of the area under the validation receiver operating characteristic curve and a previous measurement of an area under the validation receiver operating characteristic curve; and
training the binary classifier using a new value selected from the range of values for the at least one cost parameter if the difference between the measurement of the area under the validation receiver operating characteristic curve and the previous measurement of the area under the validation receiver operating characteristic curve is less than a defined threshold.

11. The method of claim 10 further comprising outputting the binary classifier if the difference between the measurement of the area under the validation receiver operating characteristic curve and the previous measurement of the area under the validation receiver operating characteristic curve is not less than a defined threshold.

12. The method of claim 8 further comprising training the binary classifier using logistic regression to predict the probability of the dwell time on the plurality of web pages of the website of each of the plurality of sponsored advertisements using the plurality of sets of features from the plurality of sets of training data.

13. The method of claim 12 further comprising:
determining a performance of training the binary classifier by measuring an area under a validation receiver operating characteristic curve;
calculating a difference between a measurement of the area under the validation receiver operating characteristic curve and a previous measurement of an area under the validation receiver operating characteristic curve; and
training the binary classifier using a new value selected from the range of values for the at least one cost parameter if the difference between the measurement of the area under the validation receiver operating characteristic curve and the previous measurement of the area under the validation receiver operating characteristic curve is less than a defined threshold.

14. The method of claim 13 further comprising outputting the binary classifier if the difference between the measurement of the area under the validation receiver operating characteristic curve and the previous measurement of the area under the validation receiver operating characteristic curve is not less than a defined threshold.

15. A computer-readable storage medium having computer-executable instructions for performing the steps comprising:
receiving a list of a plurality of sponsored advertisements for display on a web page of a plurality of search results;
predicting a probability of user navigation from each of the plurality of the sponsored advertisements using a probability of a click on each of the plurality of the sponsored advertisements and a probability of a dwell time on a plurality of web pages of a website of each of the plurality of the sponsored advertisements;
ranking the list of the plurality of sponsored advertisements at least in part by the probability of user navigation from each of the plurality of the sponsored advertisements; and
outputting the list of the plurality of sponsored advertisements in rank order at least in part by the probability of user navigation from each of the plurality of the sponsored advertisements.

16. The computer-readable storage medium of claim 15 wherein outputting the list of the plurality of sponsored advertisements in rank order at least in part by the probability of user navigation from each of the plurality of the sponsored advertisements comprises serving the list of the plurality of sponsored advertisements in rank order to a web browser executing on a client device for display on the web page of the plurality of search results.

17. The computer-readable storage medium of claim 15 wherein predicting the probability of user navigation from each of the plurality of the sponsored advertisements using the probability of the click on each of the plurality of the sponsored advertisements comprises applying a click prediction classifier to predict the probability of the click on each of the plurality of the sponsored advertisements.

18. The computer-readable storage medium of claim 17 wherein applying the click prediction classifier to predict the probability of the click on each of the plurality of the sponsored advertisements comprises receiving a plurality of features, including at least one feature of at least one user entity, at least one feature of at least one query, and at least one feature of a list of sponsored search results.

19. The computer-readable storage medium of claim 15 wherein predicting the probability of user navigation from each of the plurality of the sponsored advertisements using the probability of the dwell time on the plurality of web pages of the website of each of the plurality of the sponsored advertisements comprises applying a dwell time prediction classifier to predict the probability of the dwell time on the plurality of web pages of the website of each of the plurality of the sponsored advertisements.

20. The computer-readable storage medium of claim 19 wherein applying the dwell time prediction classifier to predict the probability of the dwell time on the plurality of web pages of the website of each of the plurality of the sponsored advertisements comprises receiving a plurality of features, including at least one feature of at least one user entity, at least one feature of at least one query, and at least one feature of a list of sponsored search results.
